(19) United States
(12) Patent Application Publication
(10) Pub. No.: US 2026/0105374 A1
(43) Pub. Date: Apr. 16, 2026

(54) SYSTEMS AND METHODS FOR GENERATING RESEARCH PREDICTIONS

(71) Applicant: Steven LEHR, Brooklyn, NY (US)

(72) Inventor: Steven LEHR, Brooklyn, NY (US)

(21) Appl. No.: 19/354,664

(22) Filed: Oct. 9, 2025

Related U.S. Application Data
(60) Provisional application No. 63/706,356, filed on Oct. 11, 2024.

(51) Int. Cl. G06N 20/00; G06N 5/022

(52) U.S. Cl. CPC G06N 20/00; G06N 5/022

(57) ABSTRACT

The disclosed technology can include a system capable of receiving a corpus of documents including a first subset of documents and a second subset of documents, where the first subset of documents and the second subset of documents are received at different time intervals, generating a credibility score and an impact score for each document of the first subset of documents, selecting a training subset from the first subset of documents based on the credibility score and the impact score, training a machine learning algorithm based on the training subset, generating, using the machine learning algorithm, a plurality of hypotheses, and evaluating the plurality of hypotheses against the second subset of documents.

### CROSS-REFERENCE TO RELATED APPLICATION

This application claims the benefit of, and priority to, U.S. Provisional Application No. 63/706,356, filed on Oct. 11, 2024, and entitled “SYSTEMS AND METHODS FOR GENERATING RESEARCH PREDICTIONS,” the disclosure of which is hereby incorporated by reference in its entirety.

### TECHNICAL FIELD

The present disclosure relates generally to systems and methods for generating research predictions and, more particularly, to generating research predictions by analyzing academic publications using artificial intelligence (AI) and other techniques.

### BACKGROUND

One of the great promises of generative Artificial Intelligence is in its potential to advance scientific inquiry. Many of the greatest scientific advances have come at the margins between disciplines, arising when ideas from one domain have been successfully applied to a different one. Despite this, scientific practice has tended to become increasingly specialized over recent decades. A fundamental issue is the sheer breadth of knowledge that has been generated by scientists. It is difficult for a human scientist to become well-versed in a single discipline, and infeasible to become equally well-versed in many different ones. This limitation does not hold for artificial intelligence systems like those based on Large Language Models (LLMs), which thrive on extremely large amounts of information. LLMs are thus theoretically capable of digesting and synthesizing knowledge from a wide breadth of sciences in ways that a human cannot. That said, no system currently exists to synthesize material from disparate scientific disciplines and generate novel concepts from its diverse knowledge base.

Large Language Models and other generative models are also capable of at least superficial novelty, in the sense that by design they create content that is based upon but outside their existing data. The ability to synthesize knowledge in ways that generate novelty raises the tantalizing possibility that such systems could be transformative in terms of helping to generate scientific content, including but not limited to novel scientific hypotheses, interpretations, and methodologies. However, the value of such contributions are necessarily limited by both the quality and usability of its output. It is now somewhat trivial to generate superficial novelty (e.g., a hypothesis that is uninteresting and/or unlikely to be true), but a more profound goal is the generation of ideas that are not only unique, but also highly likely to be true, interesting and useful; Heretofore “deep novelty.” An AI system capable of deep novelty might enable intelligent cross-pollination of ideas on a broad scale, enabling scientists and inventors to more easily answer difficult questions and solve difficult problems, thus accelerating scientific and technological progress.

Therefore, there is a long-felt but unresolved need for a system or method that facilitates deep novelty in the scientific and innovational responses of generative Artificial Intelligence Systems, and that allows the outputs from such a process to be integrated into the work of scientists and inventors, so that their value may be practically utilized.

### BRIEF SUMMARY OF THE DISCLOSURE

Briefly described, and according to one example, aspects of the present disclosure generally relate to systems and methods for employing LLMs and other AI technologies to predict scientific advancements and impacts, and systems and methods for using these predictions to interact with practitioners (including but not limited to scientists, engineers, and inventors) on a variety of critical scientific tasks, in order to enable and accelerate the practical realization and use of such advancements.

The disclosed technology can include systems and methods for training AI models to recognize and predict high-quality scientific advancement, impact and innovation. The systems and methods of the disclosed technology can include training generative models using the generated predictions. According to one example, the disclosed technology can include using machine learning processes to predict key outcomes related to research impact and quality. Such outcomes can include but are not limited to Citation Count, Replicability, Paper Downloads, Publication of Pre-Prints, Tier-1 Journal Publications, Interdisciplinary Influence/Citation, Author Collaboration Networks, Innovation Indices (e.g., measurements of novelty and non-obviousness), and Regulatory and Social Impact (e.g., citations in policy documents or media). According to this example, the disclosed technology can employ the predicted outcomes to label features of high-quality science. Further continuing this example, the disclosed technology can incorporate the identified features into LLMs or other generative models to enhance scientific capabilities.

According to a second example, the disclosed technology can use machine learning processes to predict key outcomes related to patenting and innovative designs. Such outcomes can include but are not limited to Patent Approvals, Patent Citations, Continuation Filings, and Idea Monetization Indices. According to this example, the disclosed technology can label features of high-quality innovation/patents, and incorporate the features into LLMs or other generative models to enhance inventive capabilities.

According to a third example, the disclosed systems and methods can simulate scientific advancements and innovation by using generative models to hypothesize future advancements. The disclosed systems and methods can include a feedback loop that refines the AI system based on the accuracy/success of its solutions. In this example, the disclosed technology can treat the outputs of the generative model as predictions of future advancements based on historical data on the quality of scientific advancements and innovations. The disclosed technology can compare the outputs to more recent advancements and innovations and generate variables like those described above to label the quality of the prediction. (E.g., was a predicted advance published or patented? Was it published in a Tier-1 journal? Does it appear to be replicable? And so forth.) to the disclosed technology can employ the generated variables to enhance the initial model using a variety of techniques including but not limited to Reinforcement Learning, Active Learning, and Data Augmentation and Fine Tuning.

According to a fourth example, the disclosed system and methods can employ a timebound evolutionary approach to train a generative model to gradually learn scientific/innovative context and iteratively generate better predictions around future research or innovation. In this example, the disclosed technology can train the generative model on data (e.g., research, patents) from Time Period A. The disclosed technology can tag the data with relevant meta-data, as in other examples (e.g., markers of research or patent quality). Continuing this example, the disclosed technology can train the generative model to recognize the features of higher quality research/innovation from Time Period (A). The disclosed technology can train the generative model to produce scientific/innovation material (e.g., research topics, hypotheses, inventions) based upon the learned characteristics. The disclosed system can compare the generated outputs to actual research and innovation from the next temporally proceeding period (e.g., Time Period B). For example, the disclosed system can determine which, if any, of the predictions ended up being researched/patented, and which proved to be high-quality. The disclosed system can retain the generative model based on both new data from Time Period B and its predictions and their success in this iteration. The disclosed system can repeat this process ad infinitum, e.g., generating and testing generative output for Time Period C, Time Period D, and so forth.

The disclosed system can incorporate several secondary innovations that enhance the ability to label data to identify (and thus predict) quality science and innovation, but which may be useful in additional contexts. According to one example, the disclosed system can use machine learning to identify characteristics of research (e.g., specific methodological details, statistical methods, data transparency) that predict the replicability of research. The disclosed system can allow for the prioritization of more replicable papers and/or features surrounding replicability in the training of generative models.

The disclosed system can use machine learning to detect data manipulation risks in scientific research. The disclosed system can apply lesser weight to research that may prove spurious due to ethical lapses, and thus further enables the disclosed system to prioritize research that is likely to be real and replicable in the training of generative models and in their outputs.

The disclosed technology can include the systems and methods discussed herein to enhance a generative model's ability to develop deep novelty, i.e., to generate predicted high-quality future science and innovation. The disclosed system can incorporate one or more predictions into a particular system that can assist scientists, problem-solvers, and innovators with a range of key tasks. The key tasks can vary according to the specific goal of the user. The disclosed system can use distinct ways of generating the prediction and incorporating the predictions into outputs. For example, the disclosed technology can generate a particular output with four main features that integrate the described research predictions into the particular output.

According to one example, the disclosed system and methods can include an AI-driven problem-solver. A user may share a specific problem to the AI-driven problem solver—like those currently outsourced in innovation competitions. The disclosed system and methods can generate through the AI-driven problem solver a tailored set of AI-driven recommendations for the specific problem. Similarly, a user may share the beginnings of a solution to a problem and receive from the AI-driven problem solver ideas for how to complete and improve upon the problem. Similarly, a user may share elements of an invention and receive ideas from the AI-driven problem solver on how to complete or improve the invention.

According to a second example, the disclosed system and methods can include an AI-driven Theory Generation Engine. A user may, for example, request the AI-driven Theory Generation Engine to generate theories and hypotheses that elaborate upon an existing set of research findings with plausible hypotheses. A user may also share with the AI-driven Theory Generation Engine scientific results and receive from the AI-driven Theory Generation Engine cohesive AI-driven explanations. The user can share with the AI-driven Theory Generation Engine kernels of a theory and receive from the AI-driven Theory Generation Engine further ideas and related possibilities associated with the kernels of the theory.

According to a third example, the disclosed system and methods can include an intelligent Literature Review Assistant. The intelligent Literature Review Assistant can receive from a user scientific results. The intelligent Literature Review Assistant can generate suggestions for related reading based on the scientific results. The intelligent Literature Review Assistant can receive from the user kernels of a theory or a broader topic, and The intelligent Literature Review Assistant can generate relevant related reading.

According to a fourth example, the disclosed system and methods can include an Experimental Design Optimizer. The Experimental Design Optimizer can be designed to assist researchers in creating high-quality experiments. For example, the Experimental design optimizer can receive from a user a theory. The Experimental Design Optimizer can generate methods for testing the theory. In another example, the Experimental Design Optimizer can receive information on an experimental design and can generate advice on how to improve the experimental design.

For the aforementioned examples, the disclosed technology can adjust the degree of divergence from their immediate field. For example, the disclosed system can receive a request for hypotheses or research literature drawn from only closely-related fields. In another example, the disclosed technology can receive a request for hypotheses or research literature drawn from more distant fields.

For the aforementioned examples, the disclosed technology can adjust the degree of bias toward more highly cited (and/or replicable) papers and patents, to generate outputs (hypotheses, designs etc.) that are less novel but also lower-risk (i.e. hypotheses more likely to be true), or instead riskier but more novel ideas drawn more heavily from newer or more fringe research.

For the aforementioned examples, the disclosed technology can request or suggest secondary fields or domains that should be used in the generation of outputs. For example, the disclosed technology can receive a request to generate hypotheses that lean more heavily on a particular scientific discipline and/or to suggest a discipline that may be pertinent in the area.

The disclosed systems and methods can contain several smaller engines and features, also built to enhance research practices but less directly tied to the machine-learning based prediction of future research and innovation.

The disclosed systems and methods can include an Automated Meta-Analysis Toolkit. The Automated Meta Analysis Toolkit feature offers generative AI-driven capabilities around searching for relevant articles, for automatically coding articles on potential moderators, and for coding article relevance based on inclusion and exclusion criteria.

The disclosed systems and methods can include an Analytical Strategy Recommendation Engine. The Analytical Strategy Recommendation Engine can apply AI-driven capabilities to assist researchers in selecting and implementing the most appropriate analytical techniques for their research.

The disclosed systems and methods can include a Personalized Adversarial Collaborator. The Personalized Adversarial Collaborator can generate AI-driven competing hypotheses and explanations for data, and assistance in designing studies that pry apart competing hypotheses.

The disclosed systems and methods can include a Collaborative Scientific Discovery Platform. The Collaborative Scientific Discovery Platform can integrate secure communication environments to enhance teamwork in scientific settings.

The disclosed systems and methods can include a Study Pre-Registration Facilitator. This Study Pre-Registration Facilitator can aid researchers in designing and pre-registering studies, helping them ensure adherence to best practices and enhance research credibility.

The disclosed systems and methods can include an AI Explanation System. This AI Explanation System can decode elements of the generative model's mechanisms and predictions. For example, AI Explanation System can provide detailed background for AI-driven theories, experiments, literature choices and ideas, promoting transparency through a) Supporting ideas/evidence, b) Details of cross-disciplinary pollination, and c) Suggested references.

The disclosed systems and methods can include a Personal Research Library AI Interface. The Personal Research Library AI Interface can allow a user to create a personal repository of articles for in-depth discussion and analysis.

The disclosed systems and methods can include an AI Self-Monitoring Mechanism. The AI Self-Monitoring Mechanism can proactively identify and alert users to potential inaccuracies in AI-generated content, enhancing reliability.

According to a first aspect, a machine learning method, comprising: A) receiving, via one of one or more computing devices, a corpus of documents comprising a first subset of documents published during a first timeline and a second subset of documents published during a second timeline; B) generating, via one of the one or more computing devices, a credibility score and an impact score for each document of the first subset of documents; C) selecting, via one of the one or more computing devices, a training subset from the first subset of documents based on the credibility score and the impact score; D) training, via one of the one or more computing devices, a machine learning algorithm based on the training subset; E) generating, via the machine learning algorithm, a plurality of hypotheses; and F)evaluating, via one of the one or more computing devices, the plurality of hypotheses against the second subset of documents.

According to a further aspect, the method of the first aspect or any other aspect, wherein the corpus of documents comprises at least one of a scientific article and a patent document.

According to a further aspect, the method of the first aspect or any other aspect, wherein generating the credibility score comprises using a first neural network model to generate the credibility score for each of the documents from the first subset of documents.

According to a further aspect, the method of the first aspect or any other aspect, wherein generating the impact score comprises using a second neural network model to generate the impact score for each document from the first subset of documents.

According to a further aspect, the method of the first aspect or any other aspect, wherein selecting the training subset comprises selecting one or more documents from the first subset of documents with the credibility score above a first threshold and the impact score above a second threshold.

According to a further aspect, the method of the first aspect or any other aspect, wherein generating the impact score and the credibility score further comprises de-biasing the first neural network model and the second neural network model.

According to a further aspect, the method of the first aspect or any other aspect, wherein evaluating the plurality of hypotheses against the second subset of documents comprises identifying that at least one of the plurality of hypotheses are present in the second subset of documents.

According to a further aspect, the method of the first aspect or any other aspect, wherein the machine learning algorithm comprises a large language model.

According to a further aspect, the method of the first aspect or any other aspect, wherein each of the plurality of hypotheses comprises a textual output describing a unique scientific hypothesis related a unique scientific field.

According to a further aspect, the method of the first aspect or any other aspect, wherein generating the plurality of hypothesis further comprises: A) receiving a prompt comprising a request to employ a plurality of scientific fields to generate the plurality of hypothesis; and B) generating the plurality of hypothesis based on the plurality of scientific fields.

According to a second aspect, a machine learning system, comprising: A) a data store comprising a corpus of documents comprising a first subset of documents published during a first timeline and a second subset of documents published during a second timeline; and B) at least one computing device in communication with the data store, the at least one computing device being configured to: 1) generate a credibility score and an impact score for each document of the first subset of documents; 2) select a training subset from the first subset of documents based on the credibility score and the impact score; 3) train a machine learning algorithm based on the training subset; 4) generate, via the machine learning algorithm, a plurality of hypotheses; and 5) evaluate the plurality of hypotheses against the second subset of documents.

According to a further aspect, the system of the second aspect or any other aspect, wherein the second timeline is later in time than the first timeline.

According to a further aspect, the system of the second aspect or any other aspect, wherein the computing device is further configured to identify one or more hypotheses from the plurality of hypotheses that exhibit hallucinations.

According to a further aspect, the system of the second aspect or any other aspect, wherein the computing device, via the machine learning algorithm, is further configured to regenerate the one or more hypotheses from the plurality of hypotheses identified as exhibiting hallucinations.

According to a further aspect, the system of the second aspect or any other aspect, wherein the computing device, via the machine learning algorithm, is further configured to: A) process an input prompt, the input prompt comprising a request to generate a unique scientific hypothesis for a unique scientific field; and B) generate the unique scientific hypothesis.

According to a further aspect, the system of the second aspect or any other aspect, wherein the computing device, via the machine learning algorithm, is further configured to: A) process an input prompt, the input prompt comprising a request to generate a unique patent for a unique field; and B) generate the unique patent.

According to a further aspect, the system of the second aspect or any other aspect, wherein the computing device, via the machine learning algorithm, is further configured to: A) process an input prompt, the input prompt comprising a request to help complete a solution to a scientific issue; and B) generate a potential solution to the scientific issue.

According to a third aspect, a non-transitory computer-readable medium embodying a program that, when executed by at least one computing device, causes the at least one computing device to: A) receive a corpus of documents comprising a first subset of documents published during a first timeline and a second subset of documents published during a second timeline; B) generate a credibility score and a impact score for each document of the first subset of documents; C) select a training subset from the first subset of documents based on the credibility score and the impact score; D) train a machine learning algorithm based on the training subset; E) generate, via the machine learning algorithm, a plurality of hypotheses; and F) evaluate the plurality of hypotheses against the second subset of documents.

According to a further aspect, the non-transitory computer-readable medium of the third aspect or any other aspect, wherein the program further causes the at least one computing device to: A) determine when none of the plurality of hypotheses correspond with the second subset of data; B) adjust a one or more hyperparameters of the machine learning algorithm; C) retrain the machine learning algorithm against the training subset; and D) regenerate, via the machine learning algorithm, the plurality of hypotheses.

According to a further aspect, the non-transitory computer-readable medium of the third aspect or any other aspect, wherein the program further causes the at least one computing device to: A) receive a prompt comprising a request to generate a prediction on future innovations in a unique scientific field based on the first subset of documents and the second subset of documents; and B) generate, via the machine learning algorithm and based on the prompt, the prediction.

According to a further aspect, the non-transitory computer-readable medium of the third aspect or any other aspect, wherein the program further causes the at least one computing device to: A) receive from the corpus of documents a plurality of historical data; B) identify a plurality of replicability statistics and a plurality of manipulation statistics from the historical data; and C) generating, via a first neural network, the credibility score based on the plurality of replicability statistics and the plurality of manipulation statistics.

These and other aspects, features, and benefits of the claimed invention(s) will become apparent from the following detailed written description of the preferred examples and aspects taken in conjunction with the following drawings, although variations and modifications thereto may be effected without departing from the spirit and scope of the novel concepts of the disclosure.

### BRIEF DESCRIPTION OF THE DRAWINGS

The accompanying drawings illustrate one or more examples and/or aspects of the disclosure and, together with the written description, serve to explain the principles of the disclosure. Wherever possible, the same reference numbers are used throughout the drawings to refer to the same or like elements of an example, and wherein:

FIG. 1 illustrates a networked environment, according to one example of the present disclosure.

FIG. 2 illustrates a flowchart of a process, according to one example of the present disclosure.

FIG. 3 illustrates a flowchart of a process, according to one example of the present disclosure.

### DETAILED DESCRIPTION

For the purpose of promoting an understanding of the principles of the present disclosure, reference will now be made to the examples illustrated in the drawings and specific language will be used to describe the same. It will, nevertheless, be understood that no limitation of the scope of the disclosure is thereby intended; any alterations and further modifications of the described or illustrated examples, and any further applications of the principles of the disclosure as illustrated therein are contemplated as would normally occur to one skilled in the art to which the disclosure relates. All limitations of scope should be determined in accordance with and as expressed in the claims.

Whether a term is capitalized is not considered definitive or limiting of the meaning of a term. As used in this document, a capitalized term shall have the same meaning as an uncapitalized term, unless the context of the usage specifically indicates that a more restrictive meaning for the capitalized term is intended. However, the capitalization or lack thereof within the remainder of this document is not intended to be necessarily limiting unless the context clearly indicates that such limitation is intended.

### Exemplary Embodiments

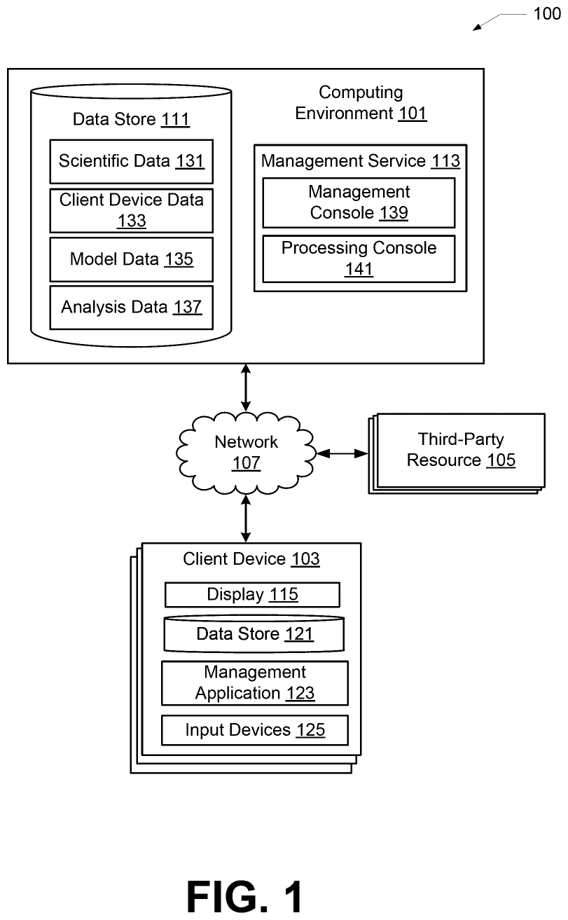

With reference to FIG. 1, illustrated is a networked environment 100, according to various examples of the present disclosure. The networked environment 100 can include a computing environment 101, one or more client devices 103, and one or more third-party resources 105, which can be in data communication with each other via a network 107. The network 107 can include, for example, the Internet, intranets, extranets, wide area networks (WANs), local area networks (LANs), wired networks, wireless networks, or other suitable networks, etc., or any combination of two or more such networks. For example, such networks can include satellite networks, cable networks, Ethernet networks, Bluetooth networks, Wi-Fi networks, NFC networks, and other types of networks.

The networked environment 100 can function as a machine learning infrastructure capable of aggregating academic publications, analyzing the academic publications, and producing various outputs based on the analyzed academic publications. For example, the networked environment 100 can process the academic publications using machine learning models and generate one or more replicability scores that quantify the likelihood that a particular study is replicable in future experimentations. In another example, the networked environment 100 can employ various machine learning models to analyze academic publications and generate one or more manipulation scores. The manipulation scores can measure a particular likelihood that a specific study includes manipulated data and information. In yet another example, the networked environment 100 can rank one or more of the academic publications based on their perceived quality (e.g., as determined by one or more scores generated by the networked environment 100) and form a dataset of academic publications that satisfy a particular score threshold. Further continuing this example, the networked environment 100 can employ the dataset for subsequent use in a large language model. The large language model can employ the dataset of academic publications to answer one or more questions input through the client device 103. For example, the client device 103 can submit a hypothesis for an experimental truss design for a hypothetical bridge construction accompanied by a question asking, “Could you provide example structures that would satisfy the hypothetical bridge construction? ” Subsequently, the large language model can process the hypothesis and the question and analyze the dataset of academic publications to generate one or more recommendations for a hypothetical bridge design. For example, the large language model of the networked environment 100 can employ a biology study of the composition of a seahorse's skeletal structure to recommend a hypothetical bridge construction that complies with the hypothesis.

By aggregating a large corpus of academic publications and analyzing the academic publications using machine learning techniques, the networked environment 100 can generate novel interdisciplinary solutions that otherwise would not have been considered. The networked environment 100 can employ extensive data storage and processing power to quickly analyze a large subset of studies spanning many disciplines to generate one or more insights that otherwise would be overlooked in distinct fields of study.

The computing environment 101 can include, for example, a server computer or any other system providing computing capability. Alternatively, the computing environment 101 can employ more than one computing device that can be arranged, for example, in one or more server banks or computer banks or other arrangements. Such computing devices can be located in a single installation or can be distributed among many different geographical locations. For example, the computing environment 101 can include one or more computing devices that together can include a hosted computing resource, a grid computing resource and/or any other distributed computing arrangement. In some cases, the computing environment 101 can correspond to an elastic computing resource where the allotted capacity of processing, network, storage, or other computing-related resources can vary over time.

The data stored in the data store 111 can include, for example, list of data, and potentially other data. The data store 111 can function as a central data center used to store and distribute data between the computing environment 101 and the client devices 103, between the computing environment 101 and the third-party resources 105, and/or between the computing environment 101 and any other system distributed across the network 107. For example, the data store 111 can store data received from the client device 103 and/or the third-party resources 105. Continuing this example, the computing environment 101 can send data from the data store 111 to the client devices 103 and/or the third-party resources 105. The data store 111 can include but is not limited to scientific data 131, client device data 133, model data 135, and analysis data 137. The scientific data 131 can include any information associated with academic publications. Academic publications can define any particular written, oral, visual, or publicized information associated with academic research and scholarship. For example, the scientific data 131 can include but is not limited to scientific journals, academic journals, academic review publications, school-sponsored publications, third-party publications, statistical data associated with academic publications, and data resources associated with one or more academic publications. The computing environment 101 can extract the scientific data 131 from the third-party resources 105 and/or the client devices 103. For example, the computing environment 101 can obtain all articles published by Nature Journal and store the articles in the scientific data 131. In another example, the computing environment 101 can extract statistical data associated with the academic publications from public datasets managed by Clarivate™ and store the statistical data in the scientific data 131. In yet another example, the computing environment 101 can process a particular academic publication to extract information associated with the particular study and store the extracted information (e.g., tables, calculations, etc.) in the scientific data 131.

The scientific data 131 can include data subcategories including but not limited to unprocessed scientific data, processed scientific data, training datasets, and testing datasets. The unprocessed scientific data can include any raw data received from the third-party resources 105, the client devices 103, and/or any other system distributed across the network 107. The processed scientific data can include any data processed by the computing environment 101. The training data set can include any particular data selected from the scientific data 131 and/or any other data stored in the data store 111 for training one or more machine learning algorithms. The testing data set can include any particular data selected from the scientific data 131 and/or any other data stored in the data store 111 for testing one or more machine learning algorithms. For example, the training data set can include a first subset of data selected from the scientific data 131, where the first subset of data can include 80% of the scientific data 131. Further continuing this example, the testing data set can include a second subset of data selected from the scientific data 131, where the second subset of data can include 20% of the scientific data 131. Further continuing this example, the training data set and the testing data set can be mutually exclusive from one another. The training data set and the testing data set can include any particular percentage distribution and can be selected from a subset of the scientific data 131 and/or any other data stored in the data store 111.

The client device data 133 can include any particular data received from the one or more client devices 103. The client device data 133 can include but is not limited to one or more inputs received through an input device 125, local data stored in a data store 121 of the client device 103, and/or any information sent from the client device 103 to the computing environment 101. For example, the client device 103 can send the computing environment 101 a text input, where the text input has a theoretical hypothesis for an experiment and a question regarding the novelty of the theoretical hypothesis. As discussed in further detail herein, the text input can be used by the computing environment 101 to analyze the scientific data 131 and generate a response to the question predicting the perceived novelty of the theoretical hypothesis. The text input can be any particular type of textual input (e.g., text document, PDF, spreadsheet) that is submitted through the client device 103.

The client device data 133 can include data associated with a particular user of the client device 103. For example, the client device 103 can send the computing environment 101 information associated with the user of the client device 103. Information associated with the user of the client device 103 can include but is not limited to an account username, an account password, an email address, a phone number, a field of study, fields of interest, an associated school, an associated company, past search results, past inputs, and/or any other information specifically associated with the particular client device 103. The client device data 133 can include device-specific information. For example, the client device data 133 can include device-specific information such that inputs and other data sent from the client device 103 are matched to the specific client device 103.

The model data 135 can include any information used to process, train, and implement machine learning models/algorithms, artificially intelligent systems, deep learning models (e.g., neural networks), large language models, and/or natural language processing systems. Non-limiting examples of models stored in the model data 135 can include topic modelers, neural networks, linear regression, logistic regression, ordinary least squares regression, stepwise regression, multivariate adaptive regression splines, ridge regression, least-angle regression, locally estimated scatterplot smoothing, decision trees, random forest classification, support vector machines, Bayesian algorithms, hierarchical clustering, k-nearest neighbors, K-means, expectation maximization, association rule learning algorithms, learning vector quantization, self-organizing map, locally weighted learning, least absolute shrinkage and selection operator, elastic net, feature selection, computer vision, dimensionality reduction algorithms, gradient boosting algorithms, and combinations thereof. Neural networks can include but are not limited to uni- or multilayer perceptron, convolutional neural networks, recurrent neural networks, long short-term memory networks, auto-encoders, variational autoencoders, denoising autoencoders, sparse autoencoders, deep Boltzmann machines, deep belief networks, back-propagations, stochastic gradient descents, Hopfield networks, gated recurrent units, generative adversarial networks, self-organizing maps, liquid state machines, spiking neural networks, echo state networks, neural turing machines, attention networks, transformer networks and radial basis function networks. The model data 135 can include a plurality of models stored in the model data 135 of varying or similar composition or function.

The models stored in the model data 135 can include various properties that can be adjusted and optimized by the corresponding engine during model training. The properties can include any parameter, hyperparameter, configuration, or setting of the model stored in the model data 135. Non-limiting examples of properties include coefficients or weights of linear and logistic regression models, weights and biases of neural network-type models, cluster centroids in clustering-type models, train-test split ratio, learning rate (e.g., gradient descent), choice of optimization algorithm (e.g., gradient descent, gradient boosting, stochastic gradient descent, Adam optimizer, XGBoost, etc.), choice of activation function in a neural network layer (e.g., Sigmoid, ReLU, Tanh, etc.), choice of value or loss function, number of hidden layers in a neural network, number of activation units (e.g., artificial neurons) in each layer of a neural network, drop-out rate in a neural network (e.g., dropout probability), number of iterations (epochs) in training a neural network, number of clusters in a clustering task, Kernel or filter size in convolutional layers, pooling size, and batch size.

The models stored in the model data 135 can include one or more large language models (LLMs). The LLMs stored in the model data 135 can include various third-party LLMs, APIs for interfacing with one or more third-party LLMs, and/or custom-programmed LLMs. For example, the LLMs stored in the model data 135 can include GPT 3.0, GPT 3.5, GPT 4.0, BERT, Lamda, and/or any other LLM system. The processing console 141 can employ the LLMs to generate one or more responses to an input received from the one or more client devices 103. For example, the processing console 141 can train the LLMs on a specific subset of the processed scientific data. Continuing this example, the processing console 141 can apply the trained LLM on the one or more inputs received from the client device 103 to generate a textual response to the particular input.

The analysis data 137 can include any data generated by the computing environment 101 and/or any other resources distributed across the network 107. The analysis data 137 can include, for example, identified classifications, extracted features, generated scores, one or more rankings, generated text, data generated for the client devices 103 and/or the third-party resources 105, and/or data generated from one or more machine learning models stored in the model data 135. The analysis data 137 can include any particular data generated from the analysis of data stored in the scientific data 131. For example, the analysis data 137 can include the one or more replicability scores based on analyzed academic publications stored in the scientific data 131. In another example, the analysis data 137 can include a ranked list of academic publications based on the perceived novelty of one or more of the academic publications. In yet another example, the analysis data 137 can include generated responses created by the LLMs of the computing environment 101 and in response to inputs received by the client device 103. Any particular information generated by the computing environment 101 can be stored in the analysis data 137. A publication evaluation score can function as a general term used for all particular scores generated by the computing environment 101 for measuring a particular quality of a specific academic publication. For example, the publication evaluation scores can include the replicability scores, manipulation scores, and/or any other score used to measure a particular quality of the specific academic publication.

Various applications and/or other functionality can be executed in the computing environment 101 according to various examples. Also, various data can be stored in a data store 111 that can be accessible to the computing environment 101. The data store 111 can be representative of one or more of data stores 111 as can be appreciated. The data stored in the data store 111, for example, can be associated with the operation of the various applications and/or functional entities described below.

For example, the components executed on the computing environment 101 can include lists of applications, and other applications, services, processes, systems, engines, or functionality discussed in detail herein. The computing environment 101 can include a management service 113. The management service 113 can function as a centralized computing resource for the computing environment 101. The management service 113 can include a management console 139 and a processing console 141. The management service 113 can perform various computing tasks for the computing environment 101, the client devices 103, the third-party resources 105, and/or any other system distributed across the network 107.

The management console 139 can manage data processed by the computing environment 101. For example, the management console 139 can organize data within the data store 111, send data to any particular device on the network 107, receive data from any particular device distributed across the network 107, and manage internal data distribution tasks of the computing environment 101. The management console 139 can communicate with the client devices 103 across the network 107 to receive various inputs generated by the client device 103. The management console 139 can interface with the third-party resources 105 to gather academic publications and other data associated with the academic publications. The management console 139 can include a timed pull request such that the academic publications are gathered from the third-party resources 105 at any particular time interval. For example, the management console 139 can generate a request sent to the third-party resources 105 for new academic publications and information. The management console 139 can subsequently analyze the academic publications and store the data in appropriate locations within the data store 111.

The processing console 141 can function as the central processing system of the computing environment 101. The processing console 141, for example, can perform one or more statistical analyses on the data stored in the data store 111, can execute one or more machine learning models on the data stored in the data store 111, can analyze one or more inputs received from the client device 103, and/or can perform any other computing requirement for the computing environment 101. The processing console 141 can employ various machine learning models to process unprocessed scientific data stored in the scientific data 131. The processing console 141 can employ various LLMs to generate one or more responses to inputs received from the client devices 103. The processing console 141 can generate reports for one or more academic publications stored in the scientific data 131. For example, the processing console 141 can generate reports for one or more academic publications discussing the replicability metrics, patentability metrics, quality metrics, manipulation metrics, and/or any other metric associated with the academic publications.

The client device 103 can be representative of one or more client devices that can be coupled to the network 107. The client device 103 can include, for example, a processor-based system such as a computer system. The computer system can be embodied in the form of a desktop computer, a laptop computer, personal digital assistants, cellular telephones, smartphones, web pads, tablet computer systems, game consoles, electronic book readers, a wearable device (e.g., smartwatches, smart-glasses), or other devices with like capabilities. The client device 103 can include a display 115. The display 115 can include, for example, one or more devices such as liquid crystal display (LCD) displays, gas plasma-based flat panel displays, organic light emitting diode (OLED) displays, electrophoretic ink (E ink) displays, LCD projectors, or other types of display devices, etc.

The client device 103 can be configured to execute various applications such as a management application 123 and/or other applications. The management application 123 can be executed in a client device 103, for example, to access network content served up by the computing environment 101 and/or other servers, thereby rendering a user interface on the display 115. To this end, the management application 123 can include, for example, a browser, a dedicated application, etc., and the user interface can include a network page, an application screen, etc. The client device 103 can execute applications beyond the management application 123 such as, for example, email applications, social networking applications, word processors, spreadsheets, and/or other applications.

The client device 103 can include the data store 121. The data store 121 can function as a local data store to the client device 103 and can share much of the same data as the computing environment 101. For example, the data store 121 can include a local copy of the client device data 133 and the analysis data 137. The data store 121 can include data specific to the particular client device 103 and not shared with other devices distributed across the network 107.

The management application 123 can facilitate an interaction between the client device 103 and the computing environment 101. For example, the management application 123 can include a web page for accessing a particular user interface with a login screen. On receiving adequate login information, the management application 123 can include a home screen for initiating a new chat dialogue. Once initiating a new chat dialogue, the management application 123 can render through the user interface a chat box for receiving written messages. The management application 123 can include a voice recording icon for receiving a voice recording through a microphone of the input devices 125. The management application 123 can include an attachment icon for uploading any particular type of attachment. On receiving a particular input through one or more of the input devices 125, the management application 123 can send the particular input to the computing environment 101 for further processing. The management application 123 can render through the user interface any particular output generated by the computing environment 101.

The input devices 125 can include any device that can generate an input for the client device 103. For example, input devices 125 can include but are not limited to keyboards, microphones, cameras, trackpads, touchscreen displays, a mouse, and/or any other pertinent input device. The input devices 125 can generate inputs for further processing by the computing environment 101. For example, the client device 103 can receive text generated from a keyboard and can send the text to the computing environment 101. In another example, the client device 103 can receive an audio recording from a microphone and can send the audio recording to the computing environment 101 for further processing. In yet another example, the client device 103 can receive a video recording from a camera illustrating a particular scientific experiment. Continuing this example, the client device 103 can send the video recording to the computing environment 101 for further processing.

The third-party resources 105 can include any particular resource used to aggregate academic publications and data associated with academic publications. The third-party resources 105 can include private university databases, public university databases, public library databases, private library databases, government databases, scholarly journal databases, private scientometrics databases (e.g., Clarivate™ databases, Scopus, Web of Science), public and publicly available scientometrics databases (e.g., Google Scholar), and/or any other database storing data associated with academic publications. The computing environment 101, through the management console 139, can pull data from the third-party resources 105. As discussed herein, the management console 139 can generate pull requests at timed intervals such that the computing environment 101 can have all up-to-data academic publications. The management console 139 can perform data scraping and other extraction techniques to pull data from the third-party resources 105.

The third-party resources 105 can also include any particular resource used to aggregate patents and data associated with patents. The third-party resources 105 can include government patent databases (e.g., United States Patent and Trademark Office, World Intellectual Property Organization), publicly available private databases (e.g., Google Patents, The Lens), private databases (e.g., Derwent Innovation, Bloomberg Law Patents & Trade Secrets), specialized analytics platforms (e.g., LexisNexisIP) academic/non-profit databases (e.g., Cambridge Corporate Innovation Index, PATSTAT), and/or any other database storing data associate with patents and other markers of innovation. Here as well, the computing environment 101, through the management console 139, can pull data from the third-party resources 105. As discussed herein, the management console 139 can generate pull requests at timed intervals such that the computing environment 101 can have all up-to-data innovation publications. The management console 139 can perform data scraping and other extraction techniques to pull data from the third-party resources 105.

Next, a general description of the operation of the various components of the networked environment 100 is provided. To begin, the processing console 141 can generate one or more replicability scores for one or more academic publications stored in the scientific data 131. The one or more replicability scores can quantify the reliability of a particular analyzed academic publication. The processing console 141 can employ one or more models from the model data 135 to generate the replicability scores. For example, the processing console 141 can employ a neural network model to score a particular academic publication to generate replicability sub-scores. The replicability sub-scores can include but are not limited to a methodological detail score, a data transparency score, a statistical methods score, a citations score, and/or any other score that measures the replicability of a particular academic publication. The processing console 141 can combine the replicability score and the manipulation score to create the credibility score.

The processing console 141 can employ one or more trained neural networks, machine learning models, and/or deep learning techniques to generate the replicability scores. For example, the processing console 141 can train a feedforward neural network to generate a probability quantifying the methodological detail present in a particular academic publication. Continuing this example, the probability quantifying the methodological detail present in the particular academic publication can range from 0 to 1, where 0 indicates that the analyzed academic publication does not have an objectively detailed methodology and where 1 represents that the analyzed academic publication does have an objectively detailed methodology. The processing console 141 can perform similar processes for any particular replicability score.

The processing console 141 can generate the replicability score by analyzing the actual replication of historical articles. For example, the management console 139 can aggregate data from a paper reporting a given result that may have generated x known replication attempts, of which y were successful or achieved some given threshold for success (e.g., a minimal effect size or statistical significance level). Continuing this example, the processing console 141 can train a neural network or other machine learning system from the model data 135 to predict replicability in a subset of papers in the scientific record based on the data gathered by the management console 139. The predictors used as inputs to the processing console 141 can include but are not limited to sources defined above (e.g., methodological detail, data transparency, statistical methods) as well as markers of open science (e.g., preregistration, data sharing), data quality where applicable, and elements of natural language processing related to the content of scientific articles. Using these individual replicability scores/elements, the processing console 141 can predict overall likelihood of replication for articles that have not yet undergone real-world replication attempts. Information about both real and predicted replicability can be used to train different elements of the processing console 141. As just one example, in generating new scientific hypotheses through the synthesis of existing science, the processing console 141 can use the replicability score to favor higher-quality research, thereby increasing the likelihood that a generated hypothesis will ultimately prove to be correct.

The processing console 141 can rank the academic publications based on the generated replicability scores. For example, the processing console 141 can average the scores for each replicability sub-score, with pertinent weights applied, to create a weighted average. The processing console 141 can store the academic publications with their associated weighted average in the processed scientific data such that the academic publications with weighted averages above a specific threshold (e.g., 80% or higher) are selected as replicable academic publications.

The processing console 141 can de-bias one or more of the models stored in the model data 135. For example, the processing console 141 can de-bias the feedforward neural network used to generate the replicability scores. The processing console 141 can perform any particular type of de-biasing technique. For example, the processing console 141 can de-bias one or more of the models by introducing a reference set during the training process. Continuing this example, the reference set introduced during the training process can include one or more academic publications that have been tagged as impartial. The processing console 141 can train the particular model with the reference set to reduce the biases of the particular model when generating the replicability scores.

The processing console 141 can debias the model data 135 by debiasing one or more machine learning models stored in the model data 135. Bias can refer to its ordinary meaning (e.g., interpersonal bias) and/or scenarios where results are skewed in some undesirable direction. In the first case, and as a non-limiting example, an algorithm can have the undesirable quality of favoring one group over another (e.g., men over women). For example, a hypothetical facial recognition software can exhibit the undesirable behavior of favoring one group over another by prioritizing the recognition of white faces over other particular groups. In another example, a hypothetical hypotheses generation system may favor hypotheses that favor one particular group over another. In another example, without the intent of the creators, a hypothetical machine learning model can favor research generated by one group over another (e.g., men over women), creating predictable bias patterns. In another example, statistical and machine learning elements can unevenly predict outcomes (e.g., professorial tenure or academic success), both in the primary function of the system and in subsequent use cases (e.g., outsourcing of the system's machine learning for predicting high-impact decisions outside of the scope of the system). In addition to these traditional examples, a system can incur undesirable biases that are not related to interpersonal elements. To continue the example of the hypotheses generation system, the system can favor novelty over replicability metrics when assessing citation counts (e.g., surprising results over real ones), thus exhibiting another form of bias. Continuing this example, it may be desirable under some circumstances to minimize a bias between particular metrics. Doing so may be achieved in various manners. In a first example, the processing console 141 can make corrections to the inputs. For example, in the case of facial recognition, the processing console 141 can select data to be more representative and/or randomized. The processing console 141 can generate corrections to the outputs. For example, the processing console 141 can select and/or preferentially weight outcomes in the predictive process that do not hold the undesirable bias. The processing console 141 can address biases within the machine-learning process. For example, the processing console 141 can assign a secondary ground truth related to the avoidance of undesirable bias to particular models of the model data 135. In the case of an interpersonal bias in a high-impact decision, for example, the processing console 141 may introduce to the selected neural network of the model data 135 a secondary dataset related to group membership. The processing console 141 can tune the neural network to predict both the main outcome (e.g., the high-impact decision) and a lack of selection bias (e.g., lower disparate impact by group membership). In another example, the processing console 141 can employ a secondary ground truth dataset defining various statistics on replicability for use in a model that predicts citation counts. Continuing this example, the processing console 141 can predict both the desired information (e.g., citation count) and lack of the undesired information (e.g., poor replicability), allowing the system and all its outputs to be tuned toward predictions/ideas (e.g., new hypotheses) that are both novel and more likely to be correct.

The processing console 141 can generate a manipulation score associated with a particular academic publication using any particular model stored in the model data 135. The manipulation score can define a probability that measures the likelihood that the particular analyzed academic publication has been manipulated. The processing console 141, for example, can employ a linear neural network to generate the manipulation score, where the manipulation score can range from 0 to 1. Continuing this example, a score of 0 can indicate that there is a high likelihood that the analyzed academic publication has been manipulated. Further continuing this example, a score of 1 can indicate that there is a low likelihood that the analyzed academic publication has been manipulated.

The processing console 141 can generate a manipulation score associated with a particular academic publication using any particular model stored in the model data 135. For example, the processing console 141 can train a machine learning algorithm from the model data 135 to generate the manipulation score based on a ground truth datasets known to contain manipulated data and non-manipulated data. The processing console 141 can train the machine learning algorithm with the ground truth dataset to identify data that has been manipulated from an input set of data. The processing console 141 can input (i.e. predictors) into the model, for example, anomalies in data distribution, distribution of outliers, instances of mismatched data formatting, entry duplication, unexpected data relationships, anomalies in metadata, Benford's law, excessive data rounding, unexpected data entries, interruptions in data collection, unexpected similarity of means across studies, other patterns that are unlikely to occur naturally, and/or any other metric used to measure data manipulation. The processing console 141 can apply the supervised model to outside data for various purposes. For example, in the training of models for the generation of scientific ideas (e.g., hypothesis generation), the processing console 141 can weigh and/or rank articles with high manipulation scores lower than articles that have lower manipulation scores. By doing so, the processing console 141 can minimize the impact of articles that likely have manipulated data.

The processing console 141 can generate one or more forecasting recommendations based on analyzed academic publications stored in the scientific data 131. The processing console 141 can employ any particular machine learning model to generate one or more forecasting recommendations. The forecasting recommendations can predict future scientific advancements in a particular field based on academic publications previously published in the same field. The processing console 141 can implement a feedback mechanism within the selected model to refine the forecasting recommendations.

The processing console 141 can employ supervised neural networks to predict key outcomes of more impactful scientific papers using historical data. For example, the processing console can employ the supervised neural networks to generate an impact score. The impact score can include one or more metrics for measuring and/or predicting, for example, a citation count, replicability scores, paper downloads, publication of pre-prints, tier 1 publications, interdisciplinary influence, journal predictor, author collaboration networks, innovation indexes (e.g., quantifying the novelty and non-obvious nature of the academic publication), and/or the regulatory or social impact of the academic publication. The processing console 141 can employ the supervised neural network to learn the attributes of impactful research. The processing console 141 can employ the output of the supervised neural network to train an LLM to recognize and generate the patterns associated with high-quality research.

For example, the processing console 141 can employ an evolutionary approach to predicting scientific progress. The processing console 141 can recursively train a particular model from the model data 135 (e.g., an LLM) on research published over a gradually expanding timeline. In this approach, the processing console 141 can train the LLM on scientific papers published through a first timeline. The processing console 141 can tag the research with relevant meta-data, including the outcomes/attributes described above (e.g., citation counts, replicability scores, etc.). Once tagged, the processing console 141 can train the LLM to recognize the features of higher-quality research from the first timeline based on the tagged meta-data. The processing console 141 can employ the LLM trained to recognize the features of high-quality research to produce scientific material (e.g., research topics, hypotheses, experimental designs) based on the learned characteristics that favor high-quality research. The processing console 141 can test the content generated by the LLM trained on the first timeline against a real corpus of scientific data from a second timeline, where the second timeline is later than the first timeline. The processing console 141 can test the content produced based on the first timeline against the data from the second timeline to identify which ideas were, in fact, researched and impactful at the second timeline. For example, the processing console 141 can determine which topics were researched, published in top journals, heavily cited, successfully replicated, etc. The processing console 141 can retrain the LLM on the new data from the second timeline and the data generated by the LLM to create a second LLM. The processing console 141 can continue this training procedure for any particular time interval and continue growing the LLM model.

The processing console 141 can use deep neural networks and/or one or more LLMs to simulate scientific or innovative developments and generate hypotheses based on the analyzed academic publications. The processing console 141 can employ a deep neural network to generate a prediction of future advancement for any particular analyzed academic publication, field, topic, or question. The processing console 141 can include various feedback loops in the deep neural network to test various hypotheses and generate an expected simulated outcome for future innovations. The processing console 141 can train the deep neural network on historical academic publications to generate predictions for future hypotheses in the particular field of study. The processing console 141 can analyze its future hypotheses against real-time academic publications received from the third-party resources 105. The processing console 141 can quantify (e.g., through vector analysis) the similarity between the generated hypotheses and the real-time academic publications. The processing console 141 can adjust one or more hyperparameters associated with the deep neural network based on the perceived differences between the generated hypotheses and the academic publications received in real time from the third-party resources 105.

The processing console 141 can use supervised neural networks and/or other modeling techniques to predict key outcomes associated with successful hypotheses in scientific fields. The attributes of successful hypotheses can include but are not limited to variables related to influence (e.g., citation counts, number of papers testing and/or extending the hypothesis, publication in tier 1 journal, article downloads), credibility (e.g., replication rates in the testing of the hypothesis), breadth of impact (e.g., incorporation of the hypothesis into real-world applications, cross-disciplinary influence, citation in patents, regulatory and social impact), and novelty (e.g., innovation indices). The processing console 141 can train any particular machine learning model from the model data 135 to identify papers based on the attributes of successful hypothesis. The processing console 141 can employ the particular machine learning model to generate key outcomes associated with successful hypotheses and use the key outcomes to train an LLM to recognize and generate responses that exhibit patterns and/or features associated with high-quality hypotheses.

The processing console 141 can recursively train a particular model on hypotheses published over a gradually expanding timeline. For example, the processing console 141 can train a generative model (e.g., an LLM) from the model data 135 on hypotheses published through a first timeline. The processing console 141 can tag research papers with relevant meta-data, including the attributes of successful hypotheses described above (e.g., related to influence, credibility, impact, novelty). The processing console 141 can train the LLM to recognize the attributes of higher-quality hypotheses from the first timeline by analyzing the tagged research papers. On training the LLM, the processing console 141 can employ the LLM to generate scientific material (e.g., new hypotheses) based on the characteristics learned from the attributes of successful hypotheses. The processing console 141 can compare the output of the LLM against data from a second timeline. The processing console 141 can determine, based on the comparison between the output of the LLM trained on the data from the first timeline and the data from the second timeline, which hypotheses were, in fact, researched and impactful during the second timeline. For example, the processing console 141 can determine which hypotheses were researched, verified, published in top journals, heavily cited, and/or successfully replicated from the second timeline. Continuing this example, the processing console 141 can compare the data generated from the LLM trained on the data from the first timeline to determine which data generated from the LLM closely relates to the data from the second timeline. The processing console 141 can retrain the LLM based on both the new data from the second timeline and predictions generated by the LLM based on the first timeline. The processing console 141 can retrain the LLM based on any particular timeline to recursively increase the corpus of data used to train the LLM.

The processing console 141 can predict one or more research impact and quality metrics for a particular analyzed academic publication stored in the client device data 133 and/or the scientific data 131. The research impact and quality metrics can include but are not limited to citation count, replicability scores, paper downloads, publication of pre-prints, tier 1 publications, interdisciplinary influence, journal predictor, author collaboration networks, innovation indexes (e.g., quantifying the novelty and non-obvious nature of the academic publication), and/or the regulatory or social impact of the academic publication. The research impact and quality metrics can be a set of predictions generated by the processing console 141 to measure the impact and quality associated with the analyzed academic publication. The processing console 141 can use any particular machine learning model to generate the predictions for the one or more research impact and quality metrics. The management console 139 can store the generated predictions for the research impact and quality metrics as sub-scores within the publication evaluation scores.

The processing console 141 can employ supervised neural networks and/or other modeling techniques to predict key outcomes associated with research impact and quality. The attributes of high-quality and impactful research may include but are not limited to replicability, successful replication, citation metrics, tier 1 publication, interdisciplinary influence, and/or paper downloads. The processing console 141 can train a particular machine learning model to learn the attributes of high-quality and high-impact research. For example, the processing console 141 can train different neural network architectures, linear modeling techniques, and/or Bayesian techniques to identify attributes of high-quality and impactful research from a particular input research paper. The processing console 141 can employ the outputs of the trained machine learning model to train an LLM to recognize and generate the patterns associated with high-quality and high-impact research.

The processing console 141 can employ an evolutionary approach to predicting the progression of scientific impact by recursively training a particular machine learning model on hypotheses published over a gradually expanding timeline. For example, the processing console 141 can train an LLM on data including higher-quality and lower-quality research published during a first timeline. The processing console 141 can tag the research with relevant meta-data, which can include but is not limited to the impact and quality metrics discussed herein. The processing console 141 can train the LLM to recognize the features of higher-quality research from the research data produced during the first timeline. On training the LLM, the processing console 141 can employ the LLM to generate scientific material (e.g., new topics, research materials, theories) based on the learned characteristics. The processing console 141 can test the generated scientific material from the LLM against research data gathered for a second timeline, where the second timeline is later than the first timeline. The processing console 141 can identify similarities between the data generated by the LLM based on the first timeline and the data gathered from the second timeline. For example, the processing console 141 can measure the accuracy of generated data from the LLM compared to the data gathered from the second timeline based on which topics were researched, verified, published in top journals, heavily cited, and/or successfully replicated. The processing console 141 can retrain the LLM based on both the new data from the second timeline and predictions generated by the LLM based on the first timeline. The processing console 141 can retrain the LLM based on any particular timeline to recursively increase the corpus of data used to train the LLM.

The processing console 141 can employ the research impact and quality predictions to label and rank particular academic publications. For example, the processing console 141 can label each of the academic publications with their respective research impact and quality metrics. Continuing this example, the processing console 141 can group the various academic publications within a particular range based on their research impact and quality metrics. The processing console 141 can group the highest-quality academic publications by grouping the academic publications with the highest research impact and quality metrics.

The processing console 141 can include two or more models from the model data to create a cascading model system for analyzing academic publications published during different time periods. The processing console 141 can employ a cascading model system such that a first model is trained with the earliest known academic publications in a specific field. The processing console 141 can generate one or more quality metrics associated with each academic publication within a specific time range assigned to the first model. The processing console 141 can employ feedback mechanisms such that the output of the first model functions as the inputs for subsequent models. For example, the processing console can employ the results from the first model as inputs into a second model, where the second model can generate one or more generated hypotheses for future innovations. The processing console 141 can train the second model for a specific time range after the first model and before the present time. The processing console 141 can analyze the generated hypotheses from the second model against real academic publications of that particular time and determine their similarities and/or differences. The processing console 141 can employ these measured differences and/or similarities to adjust the first model and other subsequent models used in the cascading model system. The processing console 141 can repeat the process for one or more time periods to generate models with accurate future hypotheses predictability.

During the evolutionary approaches discussed herein, the processing console 141 can use various modeling techniques, including but not limited to topic modelers, linear regression, logistic regression, ordinary least squares regression, stepwise regression, multivariate adaptive regression splines, ridge regression, least-angle regression, locally estimated scatterplot smoothing, decision trees, random forest classification, support vector machines, Bayesian algorithms, hierarchical clustering, k-nearest neighbors, K-means, expectation maximization, association rule learning algorithms, learning vector quantization, self-organizing map, locally weighted learning, least absolute shrinkage and selection operator, elastic net, feature selection, computer vision, dimensionality reduction algorithms, gradient boosting algorithms, and neural networks. Neural network architectures may include but are not limited to uni-or multilayer perceptron, convolutional neural networks, recurrent neural networks, long short-term memory networks, auto-encoders, variational autoencoders, denoising autoencoders, sparse autoencoders, deep Boltzmann machines, deep belief networks, back-propagations, stochastic gradient descents, Hopfield networks, gated recurrent units, generative adversarial networks, self-organizing maps, liquid state machines, spiking neural networks, echo state networks, neural turing machines, attention networks, transformer networks and radial basis function networks. The processing console 141 can use a variety of models simultaneously.

The processing console 141 can employ natural language processing systems and/or LLMs to simplify writing and mathematical concepts found in the academic publications. The processing console 141 can employ an LLM trained to simplify the language and mathematics used in the academic publications. For example, the client device 103 can request a simplified version of a particular academic publication. The processing console 141 can process the requested academic publication and return a simplified version using common language for scientific notations, technical jargon, scientific concepts, and mathematical concepts.

The processing console 141 can employ various types of model architectures for The LLMs used to interpret and/or simplify scientific content, including but not limited to Transformer-based models, Hybrid Models, Seq2Seq Models, Knowledge-Enhanced Models, Sparse Models Multimodal Models, and Fine-Tuned Domain-Specific Models. The processing console 141 can train models on scientific corpora to transmit benefits beyond mere text simplification. For example, the processing console 141 can tune the natural language processing systems and LLMs to recognize more and less important features of an article in order to draw attention to points that are important. The training across disciplines can allow the processing console 141 to draw out points that may be relevant for a particular end-user based on her/his discipline and work and may translate language from one discipline into that of another so that the end user may better understand the content and importance of an article.

The processing console 141 can generate one or more research predictions and solutions based on the analyzed academic publications stored in the scientific data 131. The processing console 141 can include one or more sub-functionalities for generating research predictions and solutions based on one or more inputs received from the client device 103. For example, the processing console 141 can receive a request for a solution that minimizes head trauma injuries caused during contact sports. The processing console 141 can extract from the scientific data 131 the highest-ranked academic publications within the field of neuroscience and biomedical engineering and train a particular LLM against the highest-ranked academic publications in the fields of neuroscience and biomedical engineering. The processing console 141 can apply the LLM to the request and generate one or more hypothetical solutions that attempt to minimize head trauma injuries caused during contact sports. The client device 103 can render a chat dialogue, allowing a continuous stream of questions and responses between the computing environment 101 and the client device 103. For example, in response to the generated solutions, the client device 103 can send follow-up questions narrowing the field of studies used as the basis for the analysis performed by the LLM. The processing console 141 can use any particular set of academic publications from any particular field of study to respond to the input sent by the client device 103.

The processing console 141 can employ the scientific prediction engines discussed herein to generate broad research-related material. Having been broadly trained to recognize and generate high-quality scientific materials and hypotheses, the processing console 141 can predict what will be a high-quality hypothesis or study within a more specific domain, such as the example discussed herein regarding a solution to minimize head trauma during contact sports. For example, based on existing knowledge, the processing console 141 can employ the scientific prediction engines discussed herein to hypothesize an intervention that may reduce head trauma. Continuing this example, the processing console 141 can tune the model's training to be likely (e.g., built on replicable research, itself predicted to be replicable), impactful (e.g., built on solutions that have received recognition, citations, patents, etc.), and practical (e.g., built on solutions that have received adoption, itself predicted to be adaptable). The processing console 141 can tune the solution to be aligned with the larger sum of knowledge (e.g., based on knowledge from all disciplines), or may be configured to favor certain kinds of knowledge or disciplines. For example, the processing console 141 can configure the prediction made by the LLM to be more patentable, by more strongly weighting the prediction of what is likely to be patentable. In another example, the processing console 141 can configure the models to favor producing data with higher efficacy by more heavily weighting research that shows large effect sizes and replicability. In another example, the processing console 141 can configure the models to draw more heavily on a particular field, for example, by more heavily weighting research published and/or predicted to be publishable in the particular field journals.

The processing console 141 can analyze scientific results input through the client device 103 against one or more academic publications stored in the scientific data 131. For example, the processing console 141 can employ an LLM and/or natural language processing systems to analyze the scientific results presented by the client device 103. The processing console 141, through the LLM, can generate a response analyzing the quality of the scientific results, recommendations for improving the scientific results, and/or any other analyses associated with the scientific results. The processing console 141 can generate alternative techniques (e.g., from different fields of study) for solving the particular issue while leading to the same, or improved scientific results. The processing console 141 can generate a report detailing its findings. For example, the processing console 141 can include in its report the predicted field associated with the scientific results.

The processing console 141 can assess the likely replicability of current research input into the computing environment 101. The processing console 141 can generate suggestions for what might improve the replicability of the present research. For example, the processing console can suggest further analyses based on a prediction around scientific impact. Continuing this example, the processing console 141 can employ one or more of the models discussed herein to generate a hypothesis that includes a particular analysis that may yield impactful results. In another example, the processing console 141, through the one or models discussed herein, can offer suggestions for follow-up studies, based on a prediction of which further research is likely to be of higher quality or impact. In yet another example, the processing console 141 can offer a prediction around where to publish the research, based on comparative predictions of likely impact within different types of journals or scientific subfields. In yet another example, the processing console through one or more models can offer solutions (e.g., follow-up experiments) that configurably draw upon different fields of research, by more heavily weighting research from a particular field or set of fields. The processing console 141, through one or more models, can generate predictions of what would be published and/or impactful within the particular field(s).

The processing console 141 can generate literary review information associated with the scientific results and/or any other input received from the client device 103. The literary review information can include but is not limited to recommendations for further reading based on a topic discussed in a particular input, recommendations for similar readings based on a theory discussed in a particular input, and/or any other recommendations for academic publications that are associated with the input sent by the client device 103.

The processing console 141 can vary weighting parameters for the one or more LLMs used to generate responses for inputs received from the client device 103. For example, the processing console 141 can be biased towards highly regarded academic publications for use in the LLMs. By varying the weight, the processing console 141 can value higher-level academic publications for use in generating a response. The processing console 141 can configure recommendations to favor more replicable research based on the determined replicability of a particular hypothesis. As another example, the processing console 141 can configure the recommendation to favor more impactful data (e.g., heavily cited articles) or, alternatively, to favor less known but high quality (based, for example, on replicability predictions) articles. In another example, the processing console 141 can favor recommendations of newer research that are determined to be impactful based on the models used to generate impact-related metrics. The processing console 141 can configure any particular model of the computing environment 101 for any particular metric the computing environment 101 is trained to predict.

The processing console 141 can generate cross-disciplinary recommendations for a particular input based on the analyzed academic publications. The processing console 141 can employ a machine learning model to recommend cross-disciplinary academic publications for a particular scientific problem input through the client device 103. For example, the computing environment 101 can receive a research idea related to social psychology. The processing console 141 can employ the machine learning model to assess the idea's likelihood of being correct based on research from another field - e.g., its alignment with known work in sociology - and then highlight supporting (or contradictory) evidence from this second field.

The processing console 141 can receive a request for a specific domain and/or field of study for analyzing a particular input from the client device 103. The processing console 141 can include an algorithm used to select academic publications that match the field of study associated with the input from the client device 103. The processing console 141 can generate data associated with a nearby field and that supports or critiques the current research based on a request received by the computing environment 101 for information that is associated with the current research.

Similarly, the processing console 141, upon receiving a request for a specific domain and/or field of study, can generate comments on an input received by the computing environment 101 (e.g., a theory, study, paper, etc.) based on the field of study. The models of the model data 135 having been trained to predict research quality (based on the various inputs described herein), can limit their content generation to a field or set of fields. For example, the processing console 141 can generate a response to a social psychological study based on data related to the field of sociology. Continuing this example, the processing console 141 can employ the trained LLMs to weight more heavily knowledge, theory, predictions (e.g., of quality and impact) within its knowledge-base around sociology. The processing console 141 through the LLM can predict what a trained sociologist might say about the input received by the computing environment 101, allowing the processing console 141 to give feedback on to the particular input through a sociological perspective.

The processing console 141, upon receiving information about an idea, theory, or experiment from the management console 139, can generate recommendations for scientific fields that are relevant but outside the user's field of expertise. For example, the user considering a particular topic/study in social psychology might receive from the processing console 141 recommendations around related material from similar fields (e.g., sociology, neuroscience) and more distant fields (e.g., evolutionary biology). The processing console 141 can generate predictions from similar and distant fields by employing the trained LLMs to search across fields for disciplines and find materials that potentially predict the idea or hypothesis posed by the user. For example, the processing console 141, through the LLMs, can rank and sort the data found in various fields to recommend relevant fields of information.

The processing console 141 can implement various elements related to meta-analysis. For example, the processing console 141 can review wide ranges of scientific literature and can tag the scientific literature based on the subject matter and the various features of the research, such as analytic strategies and specific statistical analyses.

The processing console 141 can, in response to receiving a query, access both in-house and third-party databases, and perform a search for all articles related to a particular topic or result. For example, the processing console 141 might receive from the client device 103 a request to list all articles related in any way to the relationship between diet and colon cancer.

The processing console 141 can organize decisions around the inclusion and exclusion of particular research documents. The processing console 141 can limit the list of articles by tagging relevant aspects of the research. The processing console 141 can suggest and/or receive qualitative and quantitative variables to be used for further processing. For example, a request may be transmitted through the client device 103 to the processing console 141 requesting to limit the studies gathered by the processing console 141 to peer-reviewed studies of sugar consumption and colon cancer.

The processing console 141 can tag potential moderators within articles. For example, the processing console 141 can search and label articles based on specific variables that can moderate the particular analyzed attributes discussed herein and can suggest potential forms of moderation. The processing console 141, for example, can label and/or parse the studies of sugar consumption and colon cancer based on the age of the subjects in the studies.

The processing console 141 can consolidate and record data. The processing console 141 can generate a list of relevant statistics from the group of articles being analyzed by the various models discussed herein. For example, the processing console 141 can generate a list of results, including the sample size and statistical relationships between sugar consumption and colon cancer in each article, with the results presented separately for younger and older research subjects.

The processing console 141 can analyze and aggregate data. For example, the processing console 141can generate code to calculate aggregated meta-analytic results. The results of the analysis performed by the processing console 141 can demonstrate how sugar consumption relates differently to colorectal cancer risk depending upon one's age.

The processing console 141 can generate analytics recommendations for particular inputs received from the client device 103. For example, the processing console 141 can receive a completed scientific study performed by the user of the client device 103. The processing console 141 can generate analytical strategies for adequately analyzing the data from the completed scientific study. The processing console 141 can generate the analytical strategies using one or more models discussed herein. For example, the processing console 141 can predict using one or more models discussed herein a version of the study designed to maximize key variables (e.g., replicability, impact) based on the analytical characteristics of high-quality past research.

The management application 123 can include one or more community spaces such that different accounts can interact in a public setting and share pertinent information. The processing console 141 can recommend that a first user account interacts with a second user account (e.g., connects) based on analyses performed on the client device data 133. For example, the processing consoler 141 can recommend a connection between a user account that shares similar profile information as a second user account.

The processing console 141 can include publication requirements and other formatting information. The processing console 141 can train the LLM modes to generate recommendations for improving studies by adhering to particular publication and formation requirements.

The processing console 141 can act as a personal “adversarial collaborator.” An adversarial collaborator can be defined as a first individual who has a competing theory to a similar problem as compared to a second individual, and the first individual and the second individual collaborate to reach a shared result. For example, the processing console 141 can receive a hypothesis from the client device 103, requesting an analysis and response that mimics an adversarial collaborator. The processing console 141 can employ the prior trained LLM(s) to generate a competing alternative hypothesis to that of the input. The hypothesis generated by the LLM(s) can function as a “prediction” of future results, tuned to be maximally plausible based on the modeling processes outlined above, but differing from the theory associated with the input. For example, the processing console 141 can generate an experiment that will test the two competing hypotheses, allowing the user to discern which one is correct.

The processing console 141 can surface a research plugin in the management application 123 of the client device 103. The research plugin can interface with the processing console 141 to receive relevant research information associated with the particular scientific results. For example, the research plugin can interface with LLMs and other resources of the processing console 141 to generate relevant research information associated with the particular scientific results.

The processing console 141 can monitor in real time the academic publications and/or any other information received from the third-party resources 105 for plagiarism and other academic issues. For example, the client device 103 can send the processing console 141 a specific scientific result. Continuing this example, the processing console 141 can reference the academic publications from the third-party resources 105 to identify plagiarism and other academic issues.

The processing console 141 can pre-process any outputs generated for the models in the model data 135 for hallucinations and other issues. The processing console 141 can flag and re-evaluate any process that generates a result that is deemed a hallucination. The processing consoler 141 can continually audit results to minimize the amount of erroneous information distributed across the networked environment 100.

During the generation of research recommendations, the processing console 141 can validate the reference within a secondary database of articles prior to generating the particular research recommendations. For example, if a reference is unable to be verified, the processing console 141 can determine that the generated response is a hallucination and the processing console 141 can delete the research recommendation.

The processing console 141 can perform similar metric analysis on patent applications. For example, the management console 141 can aggregate one or more patent applications from public patent databases. The processing consoles 141 can store the patent applications as a sub-category in the scientific data 131. The processing console 141 can process the patent applications to generate one or more metrics that measure the quality of the analyzed patent application. For example, the processing console 141 can employ a random forest classification algorithm from the model data 135 to generate one or more metrics that measure the quality of the analyzed patent application. The one or more metrics that can measure the quality of the analyzed patent application can include but are not limited to approval metrics, patent reference citations, continuation likelihood, claims quality scores, specification quality scores, field saturation scores, examiner scores, and/or any other metric pertinent to the quality of the analyzed patent application. The one or more metrics can also include information from outside databases related to the invention's practical application, such as business results related to the monetization of the patent. The processing console 141 can rank the analyzed patent applications based on the generated metrics and group various applications on their perceived quality.

The processing console 141 can use supervised neural networks and/or other modeling techniques to predict key outcomes associated with patent quality. The processing console 141 can use modeling techniques such as but not limited to topic modelers, linear regressions, logistic regressions, ordinary least squares regression, stepwise regression, multivariate adaptive regression splines, ridge regression, least-angle regression, locally estimated scatterplot smoothing, decision trees, random forest classification, support vector machines, Bayesian algorithms, hierarchical clustering, k-nearest neighbors, K-means, expectation maximization, association rule learning algorithms, learning vector quantization, self-organizing map, locally weighted learning, least absolute shrinkage and selection operator, elastic net, feature selection, computer vision, dimensionality reduction algorithms, gradient boosting algorithms, and neural networks. Neural network architectures may include but are not limited to uni-or multilayer perceptron, convolutional neural networks, recurrent neural networks, long short-term memory networks, auto-encoders, variational autoencoders, denoising autoencoders, sparse autoencoders, deep Boltzmann machines, deep belief networks, back-propagations, stochastic gradient descents, Hopfield networks, gated recurrent units, generative adversarial networks, self-organizing maps, liquid state machines, spiking neural networks, echo state networks, neural Turing machines, attention networks, transformer networks and radial basis function networks. A processing console 141 can use one or more models to generate patent-related responses.

This processing console 141 can employ the data in the data store 111 to train one or more machine learning models to identify and/or generate the attributes of high-quality innovations (e.g., patent approvals, references, and other metrics discussed herein). The processing console 141 can employ the outputs of the particular model that identifies and/or generates the attributes of high-quality innovations to train an LLM to recognize and generate the patterns associated with high-quality innovations.

The processing console 141 can employ an evolutionary approach to predict the progression of innovation by recursively training a model on patents published over a gradually expanding timeline. For example, the processing console 141 can train a generative model (e.g., an LLM) using data that includes high-quality and low-quality innovations from a first timeline. The processing console 141 can tag the research with relevant meta-data such as patent approvals, business results, and/or other patent related metrics. The processing console 141 can train the particular model to recognize the features of higher-quality and impactful innovations from the first timeline. Once trained, the processing console 141 can employ the LLM to produce innovative material (e.g., new ideas, inventions, solutions) based on the learned characteristics. The processing console 141 can test the results generated by the LLM based on the data from the first timeline against patent and other related data gathered from a second timeline. The processing console 141 can identify which innovations generated by the LLM based on the data from the first timeline are most similar to the data from the second timeline. The processing console 141 can retrain the LLM based on both the new data from the second timeline and the data generated by the LLM based on the data from the first timeline. The processing console 141 can continually retrain the LLM with distinct time intervals.

The processing console 141 can use deep neural networks and/or one or more LLMs to simulate innovative developments and generate potential innovation (e.g., ideas for inventions, solutions to problems) based on the analyzed patent publications. The processing console 141 can employ a deep neural network to generate a prediction of future advancement in any given domain or industry. The processing console 141 can include various feedback loops in the deep neural network to test various hypotheses and generate an expected simulated outcome for future innovations.

The processing console 141 can receive a request around a specific problem requiring a particular innovative idea based on an input from the client device 103. The processing console 141 can generate potential solutions to the stated problem from the input. For example, a company or individual can require a new method for synthesizing a particular chemical. The processing console 141 can receive the request for the new method for synthesizing particular chemicals and can generate one or more responses with one or more potential solutions. The processing console 141 can generate prediction of a solution based on the supervised training of the LLM.

In another example, the processing console 141 can receive an input from a client device requesting a partial solution or idea for a particular problem. The processing console 141 can generate ideas for how to complete the solution and/or present alternative solutions. For example, the processing console 141 can generate a prediction of what a high-quality solution might be, based on the supervised training of the system to recognize and predict high-quality patents and scientific articles.

In another example, the processing console 141 can receive an input from the client device 103, where the input can include an idea or partial design for an invention or solution or for elements of an invention. The processing console 141 can generate ideas for how to complete or improve the invention. The processing console 141 can generate the recommendation using machine learning-driven predictions of what a high-quality version of the invention might look like.

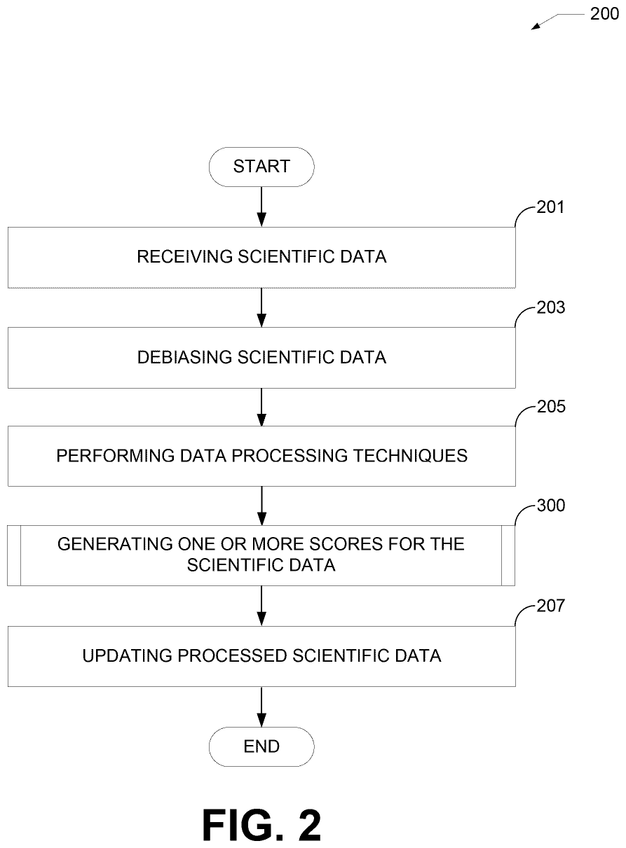

Referring now to FIG. 2, illustrates is a flowchart of a process 200, according to one embodiment of the present disclosure. The process 200 can illustrate a technique for processing academic publications received from the one or more third-party resources 105. The process 200 can be applied to any data stored in the scientific data 131 and/or the client device data 133. For example, the processing console 141 can apply the process 200 to privately store scientific studies stored in the client device data 133 and associated with a particular client device 103.

At box 201, the process 200 can include receiving scientific data 131 from the one or more third-party resources 105. The management console 139 can receive academic publications and/or any other information from the third-party resources 105. The management console 139 can generate timed requests to receive academic publications from the third-party resources 105 in real time. The management console 139 can store any data gathered from the third-party resources 105 in the scientific data 131.

At box 203, the process 200 can include de-biasing the scientific data. The processing console 141 can de-bias the raw data received from the third-party resources 105 to reduce the likelihood of using biased data when training one or more machine learning models. For example, the processing console 141 can remove academic publications that come from low-impact score academic journals.

At box 205, the process 200 can include performing data processing techniques on the academic publications stored in the scientific data 131. The processing console 141 can perform data processing techniques on the academic publications to aid the machine learning models during training and subsequent use. For example, the processing console 141 can remove data gaps present in the scientific data 131. In another example, the processing console 141 can perform feature extraction to extract one or more features associated with the academic publications. In yet another example, the processing console 141 can remove outliers from the scientific data 131, reduce the dimensionality of the particular scientific data, scale one or more data points in the scientific data 131, and/or perform any other data processing technique.

The process 200 can include the process 300. The process 300 can include generating one or more scores for the academic publications stored in the scientific data 131. The processing consoler 141 can employ any particular machine learning model in the model data 135 to generate one or more scores associated with the academic publications. For example, the processing console 141 can employ any particular machine learning model to generate any of the publication evaluation scores. The publication evaluation scores can be associated with their respective academic publication for further processing.

At box 207, the process 200 can include updating the processed scientific data. The management console 139 can update the processed scientific data within the scientific data 131. The management console 139 can tag each of the particular academic publications with their associated metrics and store the academic publications in the scientific data 131.

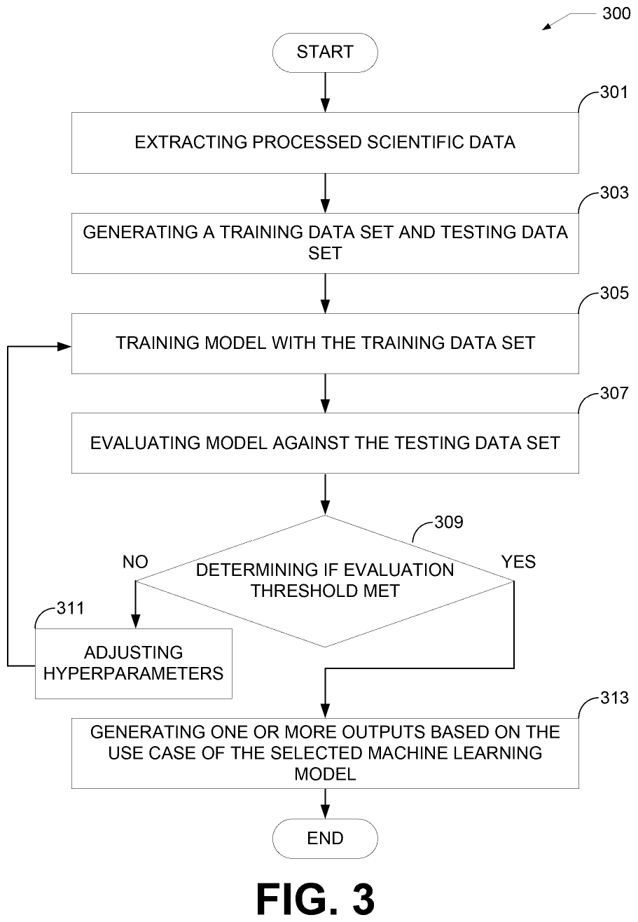

Referring now to FIG. 3, illustrated is a flowchart of a process 300, according to one embodiment of the present disclosure. The process 300 may demonstrate a technique for implementing one or more of the machine learning models employed by the processing console 141. The process 300 may function for any model in the model data 135. For example, the processing console 141 may implement the process 300 for generating the replicability scores, the manipulation scores, and/or any other output generated by the processing console 141.

At box 301, the process 300 can include extracting processed scientific data from the scientific data 131. For example, the processing console 141 can extract the analyzed academic publications from the scientific data 131. The processing console 141 can extract processed scientific data based on the needs of the model. For example, for generating the replicability scores, the processing console 141 can extract the highest-ranked academic publications based on their respective replicability scores. In another example, the processing consoler 141 can randomly select a subsection of the analyzed scientific data for further processing.

At box 303, the process 300 includes generating a training data set and a testing data set. The processing console 141 can generate the training data set and the testing data set by creating two mutually exclusive subsets of data from the scientific data 131, the client device data 133, and/or any other pertinent data. The training data set can be defined as a data set used to train the machine learning model to identify particular trends in the data, make predictions on the data, extract features pertinent to the data, and determine a conclusion based on the data. The testing data set can be defined as a set of data with similar content as the training data sat that has not been seen by the machine learning model to test the validity of the machine learning model. The processing console 141 can form the training data set and the testing data set by separating a subset of the scientific data 131 and the client device data 133 into two mutually exclusive subsets of data. For example, the processing console 141 can split a subset of the scientific data 131 and the client device data 133, where 80% of the data is stored in the testing data set and the remaining 20% is stored in the testing data set. The processing console 141 may insure that the data present in the training data set is not present in the testing data set and vise-versa. Though discussed as an 80/20 split, any particular percentage amount may be used to form the training data set and the testing data set.

The processing console 141 can vary the type of data included in the training data set and the testing data set based on the application of the particular model. For example, the processing console 141 can use distinct training and testing data sets when training a classification algorithm for feature extraction as compared to an LLM for generating response to inputs sent by the client device 103.

At box 305, the process 300 can include training the model with the training data set. The processing console 141 can train the selected machine learning model with the training data set. For example, the processing console 141 can employ deep learning techniques for generating one or more responses to inputs received from the client device 103. By training with the training data, the selected machine learning model can build an ability to identify trends in the academic publications over a period of time, extract features associated with academic publications, and generate one or more responses to the inputs received from the client devices 103.

At Box 307, the process 300 can include evaluating the model against the training data set. The processing console 141 can evaluate the selected machine learning model by testing the model against the training data set. The processing console 141 can generate an analysis score based on how well the selected machine learning model interprets and produces outputs based on the testing data set. For example, the processing console 141 can measure how well the selected machine learning model can interpret the input received from the client device 103 and generate a replicability score based on the historical replicability scores of similar academic publications.

At box 309, the process 300 can include determining if an analysis threshold has been met. The processing console 141 can compare the analysis score to the analysis threshold to test the accuracy, ability, and correctness of the selected machine learning model. For example, the processing console 141 can require that the analysis score is greater than 95% to satisfy the analysis threshold. Continuing this example, if the analysis score satisfies the analysis threshold (e.g., the analysis score is greater than 95%), the processing console 141 can determine that the selected machine learning model has successfully analyzed the training data and adequately generated the desired output. If the processing console 141 determines that the analysis threshold is met, the process 300 may proceed to box 313. If the processing console 141 determines that the analysis threshold has not been met, the process 300 may proceed to box 311.

At box 311, the process 300 can include adjusting hyperparameters of the machine learning model. The selected machine learning model can include one or more hyperparameters. Hyperparameters can be defined as parameters that control the learning process of the selected machine learning model and cannot be directly calculated by the model. In certain embodiments, the processing console 141 can generate updated hyperparameters to tailor the selected machine learning model and to adjust its analysis of the training and testing data sets. Once the processing console 141 adjusts the hyperparameters, the process 300 may continue to the box 305 to retrain and reevaluate the selected machine learning model.

At box 313, the process 300 can include generating on or more outputs based on the use case scenario of the selected machine learning model. The processing console 141 can generate one or more outputs based on the use case scenario of the selected machine learning model. For example, the processing console can produce one or more publication evaluation scores for any particular academic publication. In another example, the processing console 141 can generate, through the selected machine learning model (e.g., an LLM), a textual response to a request for a theoretical hypothesis. The processing console 141 can store the evaluated machine learning model in the model data 135. When needed, the processing console 141 may extract the evaluated machine learning model to run against updated scientific data 131, client device data 133, and/or any other analyzed data.

From the foregoing, it will be understood that various aspects of the processes described herein are software processes that execute on computer systems that form parts of the system. Accordingly, it will be understood that various examples of the system described herein are generally implemented as specially-configured computers including various computer hardware components and, in many cases, significant additional features as compared to conventional or known computers, processes, or the like, as discussed in greater detail herein. Examples within the scope of the present disclosure also include computer-readable media for carrying or having computer-executable instructions or data structures stored thereon. Such computer-readable media can be any available media which can be accessed by a computer, or downloadable through communication networks. By way of example, and not limitation, such computer-readable media can comprise various forms of data storage devices or media such as RAM, ROM, flash memory, EEPROM, CD-ROM, DVD, or other optical disk storage, magnetic disk storage, solid-state drives (SSDs) or other data storage devices, any type of removable non-volatile memories such as secure digital (SD), flash memory, memory stick, etc., or any other medium which can be used to carry or store computer program code in the form of computer-executable instructions or data structures and which can be accessed by a general-purpose computer, special purpose computer, specially-configured computer, mobile device, etc.

When information is transferred or provided over a network or another communications connection (either hardwired, wireless, or a combination of hardwired or wireless) to a computer, the computer properly views the connection as a computer-readable medium. Thus, any such a connection is properly termed and considered a computer-readable medium. Combinations of the above should also be included within the scope of computer-readable media. Computer-executable instructions comprise, for example, instructions and data which cause a general-purpose computer, special purpose computer, or special purpose processing device such as a mobile device processor to perform one specific function or a group of functions.

Those skilled in the art will understand the features and aspects of a suitable computing environment in which aspects of the disclosure may be implemented. Although not required, some of the examples of the claimed innovations may be described in the context of computer-executable instructions, such as program modules or engines, as described earlier, being executed by computers in networked environments. Such program modules are often reflected and illustrated by flow charts, sequence diagrams, exemplary screen displays, and other techniques used by those skilled in the art to communicate how to make and use such computer program modules. Generally, program modules include routines, programs, functions, objects, components, data structures, application programming interface (API) calls to other computers whether local or remote, etc. that perform particular tasks or implement particular defined data types, within the computer. Computer-executable instructions, associated data structures and/or schemas, and program modules represent examples of the program code for executing steps of the methods disclosed herein. The particular sequence of such executable instructions or associated data structures represents examples of corresponding acts for implementing the functions described in such steps.

Those skilled in the art will also appreciate that the claimed and/or described systems and methods may be practiced in network computing environments with many types of computer system configurations, including personal computers, smartphones, tablets, hand-held devices, multi-processor systems, microprocessor-based or programmable consumer electronics, networked PCs, minicomputers, mainframe computers, and the like. Examples of the claimed innovation are practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing various aspects of the described operations, which is not illustrated, includes a computing device including a processing unit, a system memory, and a system bus that couples various system components including the system memory to the processing unit. The computer will typically include one or more data storage devices for reading data from and writing data to. The data storage devices provide nonvolatile storage of computer-executable instructions, data structures, program modules, and other data for the computer.

Computer program code that implements the functionality described herein typically comprises one or more program modules that may be stored on a data storage device. This program code, as is known to those skilled in the art, usually includes an operating system, one or more application programs, other program modules, and program data. A user may enter commands and information into the computer through keyboard, touch screen, pointing device, a script containing computer program code written in a scripting language, or other input devices (not shown), such as a microphone, etc. These and other input devices are often connected to the processing unit through known electrical, optical, or wireless connections.

The computer that affects many aspects of the described processes will typically operate in a networked environment using logical connections to one or more remote computers or data sources, which are described further below. Remote computers may be another personal computer, a server, a router, a network PC, a peer device or other common network node, and typically include many or all of the elements described above relative to the main computer system in which the innovations are embodied. The logical connections between computers include a local area network (LAN), a wide area network (WAN), virtual networks (WAN or LAN), and wireless LANs (WLAN) that are presented here by way of example and not limitation. Such networking environments are commonplace in office-wide or enterprise-wide computer networks, intranets, and the Internet.

When used in a LAN or WLAN networking environment, a computer system implementing aspects of the innovation is connected to the local network through a network interface or adapter. When used in a WAN or WLAN networking environment, the computer may include a modem, a wireless link, or other mechanisms for establishing communications over the wide-area network, such as the Internet. In a networked environment, program modules depicted relative to the computer, or portions thereof, may be stored in a remote data storage device. It will be appreciated that the network connections described or shown are exemplary and other mechanisms of establishing communications over wide area networks or the Internet may be used.

While various aspects have been described in the context of a preferred example, additional aspects, features, and methodologies of the claimed innovations will be readily discernible from the description herein, by those of ordinary skill in the art. Many examples and adaptations of the disclosure and claimed innovations other than those herein described, as well as many variations, modifications, and equivalent arrangements and methodologies, will be apparent from or reasonably suggested by the disclosure and the foregoing description thereof, without departing from the substance or scope of the claims. Furthermore, any sequence(s) and/or temporal order of steps of various processes described and claimed herein are those considered to be the best mode contemplated for carrying out the claimed innovations. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in a variety of different sequences and orders, while still falling within the scope of the claimed innovations. In addition, some steps may be carried out simultaneously, contemporaneously, or in synchronization with other steps.

The examples were chosen and described in order to explain the principles of the claimed innovations and their practical application so as to enable others skilled in the art to utilize the innovations and various examples and with various modifications as are suited to the particular use contemplated. Alternative examples will become apparent to those skilled in the art to which the claimed innovations pertain without departing from their spirit and scope. Accordingly, the scope of the claimed innovations is defined by the appended claims rather than the foregoing description and the exemplary examples described therein.

What is claimed is:

1. A machine learning method, comprising:
receiving, via one of one or more computing devices, a corpus of documents comprising a first subset of documents published during a first timeline and a second subset of documents published during a second timeline;
generating, via one of the one or more computing devices, a credibility score and an impact score for each document of the first subset of documents;
selecting, via one of the one or more computing devices, a training subset from the first subset of documents based on the credibility score and the impact score;
training, via one of the one or more computing devices, a machine learning algorithm based on the training subset;
generating, via the machine learning algorithm, a plurality of hypotheses; and
evaluating, via one of the one or more computing devices, the plurality of hypotheses against the second subset of documents.

2. The machine learning method of claim 1, wherein the corpus of documents comprises at least one of a scientific article and a patent document.

3. The machine learning method of claim 1, wherein generating the credibility score comprises using a first neural network model to generate the credibility score for each of the documents from the first subset of documents.

4. The machine learning method of claim 3, wherein generating the impact score comprises using a second neural network model to generate the impact score for each document from the first subset of documents.

5. The machine learning method of claim 1, wherein selecting the training subset comprises selecting one or more documents from the first subset of documents with the credibility score above a first threshold and the impact score above a second threshold.

6. The machine learning method of claim 4, wherein generating the impact score and the credibility score further comprises de-biasing the first neural network model and the second neural network model.

7. The machine learning method of claim 1, wherein evaluating the plurality of hypotheses against the second subset of documents comprises identifying that at least one of the plurality of hypotheses are present in the second subset of documents.

8. The machine learning method of claim 1, wherein each of the plurality of hypotheses comprises a textual output describing a unique scientific hypothesis related a unique scientific field.

9. The machine learning method of claim 1, wherein generating the plurality of hypothesis further comprises:
receiving a prompt comprising a request to employ a plurality of scientific fields to generate the plurality of hypothesis; and
generating the plurality of hypothesis based on the plurality of scientific fields.

10. A machine learning system, comprising:
a data store comprising a corpus of documents comprising a first subset of documents published during a first timeline and a second subset of documents published during a second timeline; and
at least one computing device in communication with the data store, the at least one computing device being configured to:
generate a credibility score and an impact score for each document of the first subset of documents;
select a training subset from the first subset of documents based on the credibility score and the impact score;
train a machine learning algorithm based on the training subset;
generate, via the machine learning algorithm, a plurality of hypotheses; and
evaluate the plurality of hypotheses against the second subset of documents.

11. The machine learning system of claim 10, wherein the second timeline is later in time than the first timeline.

12. The machine learning system of claim 10, wherein the computing device is further configured to identify one or more hypotheses from the plurality of hypotheses that exhibit hallucinations.

13. The machine learning system of claim 12, wherein the computing device, via the machine learning algorithm, is further configured to regenerate the one or more hypotheses from the plurality of hypotheses identified as exhibiting hallucinations.

14. The machine learning system of claim 10, wherein the computing device, via the machine learning algorithm, is further configured to:
process an input prompt, the input prompt comprising a request to generate a unique scientific hypothesis for a unique scientific field; and
generate the unique scientific hypothesis.

15. The machine learning system of claim 10, wherein the computing device, via the machine learning algorithm, is further configured to:
process an input prompt, the input prompt comprising a request to generate a unique patent for a unique field; and
generate the unique patent.

16. The machine learning system of claim 10, wherein the computing device, via the machine learning algorithm, is further configured to:
process an input prompt, the input prompt comprising a request to help complete a solution to a scientific issue; and
generate a potential solution to the scientific issue.

17. A non-transitory computer-readable medium embodying a program that, when executed by at least one computing device, causes the at least one computing device to:
receive a corpus of documents comprising a first subset of documents published during a first timeline and a second subset of documents published during a second timeline;
generate a credibility score and a impact score for each document of the first subset of documents;
select a training subset from the first subset of documents based on the credibility score and the impact score;
train a machine learning algorithm based on the training subset;
generate, via the machine learning algorithm, a plurality of hypotheses; and
evaluate the plurality of hypotheses against the second subset of documents.

18. The non-transitory computer-readable medium of claim 17, wherein the program further causes the at least one computing device to:
determine when none of the plurality of hypotheses correspond with the second subset of data;
adjust a one or more hyperparameters of the machine learning algorithm;
retrain the machine learning algorithm against the training subset; and
regenerate, via the machine learning algorithm, the plurality of hypotheses.

19. The non-transitory computer-readable medium of claim 17, wherein the program further causes the at least one computing device to:
receive a prompt comprising a request to generate a prediction on future innovations in a unique scientific field based on the first subset of documents and the second subset of documents; and
generate, via the machine learning algorithm and based on the prompt, the prediction.

20. The non-transitory computer-readable medium of claim 17, wherein the program further causes the at least one computing device to:
receive from the corpus of documents a plurality of historical data;
identify a plurality of replicability statistics and a plurality of manipulation statistics from the historical data; and
generating, via a first neural network, the credibility score based on the plurality of replicability statistics and the plurality of manipulation statistics.
